(19) United States
(12) Patent Application Publication
(10) Pub. No.: US 2018/0339602 A1
(43) Pub. Date: Nov. 29, 2018

(54) METHOD, STORAGE MEDIUM, AND SERVER APPARATUS FOR COMMUNICATING A CHARGING OPPORTUNITY FOR A MOTOR VEHICLE

(71) Applicant: AUDI AG, Ingolstadt (DE)

(72) Inventor: Markus LANG, Sappenfeld (DE)

(73) Assignee: AUDI AG, Ingolstadt (DE)

(21) Appl. No.: 15/983,132

(22) Filed: May 18, 2018

(30) Foreign Application Priority Data
May 23, 2017 (DE) 102017208691.2

(51) Int. Cl. B60L 11/18; G01C 21/34; G06Q 10/02; G06Q 50/06

(52) U.S. Cl. CPC B60L 11/1838; G01C 21/3476; B60L 2240/72; G06Q 50/06; G06Q 10/02

(57) ABSTRACT

A method for communicating a charging opportunity for a motor vehicle. Accordingly, a server administers a database of charging opportunities. In response to a corresponding inquiry, a charging opportunity is selected from the database by way of the server, and data corresponding to said charging opportunity are transmitted to the driver of the motor vehicle. In addition, it is provided that the selected charging opportunity is reserved for the driver by way of the server. The invention further relates to a storage medium [and] to a program code representing the method [and] to a server apparatus having such a storage medium.

### FIELD

The invention relates to a method for communicating a charging opportunity for a traction battery of a motor vehicle to a driver of the motor vehicle. In addition, the invention relates to a storage medium with a corresponding program code representing a method of this kind, and a server apparatus with such a storage medium.

### BACKGROUND

DE 10 2009 052 927 A1 describes a motor vehicle with an electric drive, a charging interface for charging an electric energy storage unit of the motor vehicle, and a recording device for recording the quantity of energy transferred via the charging interface. It should be possible therewith, for example, to charge the energy storage unit at a private power terminal of a host and appropriately to reimburse the host for the quantity of energy that is made available.

DE 10 2009 030 090 A1 is also concerned with the determination of procured quantities of energy. In this case, on the side of the motor vehicle, a first quantity of energy that is exchanged with a power tap, and, on the side of the power tap, a total quantity of energy are thereby recorded. The latter is formed from the sum of the first quantity of energy and a second quantity of energy that is made available by the power tap independently of the electric vehicle. For determination of the second quantity of energy, the first quantity of energy received by the vehicle is subtracted from the total quantity of energy. Accordingly, a vehicle identification number can be known in the power tap and can be used to be able to bill the energy procured by the vehicle. Thus, the charging of electric vehicles should be made possible at public and semipublic sockets, without it being necessary equip said sockets with special meters.

DE 10 2009 043 306 A1 describes a monitoring system and a method for monitoring an energy transfer between a first energy unit and a second energy unit. An RFID identification code is exchanged between the energy units and information on the quantity of energy is transmitted to an energy communication unit of a power grid. The energy units can be, for example, an electric vehicle and a socket, wherein the socket releases a flow of current only after successful identification of the electric vehicle. Through a battery management system, it is possible, on the basis of provided information, to calculate when and where the particular driver will arrive after the next journey and to transmit a curve of a power need over time to a network operator. Flexible electrical power prices can thus be utilized.

### SUMMARY

The object of the present invention is to improve a practicability of a motor vehicle with an electric drive in view of a limited range of travel and a limited number of charging possibilities.

This object is achieved in accordance with the invention by the subjects of the independent patent claims. Advantageous embodiments of the invention are presented in the dependent patent claims as well as in the following description and in the drawings.

In the method according to the invention for communicating a charging opportunity for a traction battery of a motor vehicle to a driver of the motor vehicle, a database of charging opportunities is made available by means of a server. In this database, therefore, at least the charging opportunity that is to be communicated is stored. An inquiry for a charging opportunity is received from the driver through the server, and, depending on this inquiry, a or the charging opportunity that is ultimately to be communicated is selected from the database. Data corresponding to the selected charging opportunity are transmitted to the driver by the server and the selected charging opportunity is reserved for the driver.

The motor vehicle can be, for example, an electric vehicle or a hybrid vehicle. A charging opportunity in the sense of the present invention is understood to mean a charging station that is free in a specific period of time, that is, is available and accessible for charging the motor vehicle or the traction battery thereof. A charging opportunity for a specific period of time and the availability thereof in the period of time are therefore provided. The charging station can be, in principle, any power terminal that is suitable for charging the motor vehicle, such as, for example a public or semipublic charging station and, in particular, also a private charging station and, in particular, an online-enabled charging station. In the database, different kinds of charging opportunities or charging stations can thereby be stored. In a variant, it is possible to store in the database, in particular exclusively, charging opportunities offered by private persons. A database of charging opportunities offered by private persons—in contrast to companies—can be realized advantageously more simply if need be, for example, without requirements or with fewer requirements [than]¹ for commercial offers. Therefore, each user can offer said his own charging opportunities or electric energy to other users.

The charging opportunities recorded in the database can be transmitted by a respective operator of the charging station or by a respective vendor of the charging opportunity or by the respective charging station or a device of the charging station to the server, that is, they can be received by the server.

In the database, it is possible, in particular, to store respective sites or addresses of the charging opportunities or charging possibilities. Preferably, it is possible, beyond this, to store in the database additional data relating to the respective charging opportunity, that is, corresponding to the particular charging opportunity. This may comprise, for example, a particular power capacity, a kind or a type of charging opportunity, particular periods of availability, and/or a price for the energy that can be procured by way of the particular charging opportunity and/or more of such data.

It is possible through the server, therefore, to record the particular period of availability and/or the particular electrical power capacity in the database for each charging opportunity stored in the database. The period of availability indicates the times at which the charging opportunity makes possible a charging of a vehicle. The electrical power capacity indicates what electrical power can be called upon at the charging opportunity or the corresponding charging station for charging the vehicle. The specifications of the period of availability and/or of the power capacity make possible an appropriate selection of a suitable charging opportunity. The period of availability and/or the power capacity can also be transmitted to the driver, as a result of which the driver is given a better estimate or evaluation of the charging opportunity. For example, the driver can thereby estimate whether a time delay in reaching the site of the charging opportunity due to a short period of availability, for example, will result in the inability of the vehicle to be charged as intended.

Preferably, the charging stations or the operating devices associated therewith are connected to the server via a data link or a data network, so that a communication can take place between the server and the respective charging station in order to update the data stored in the database, for example. Thus, it is possible, for example, for the respective charging station to transmit a status report to the server routinely and/or when there is a change in its occupancy or availability status. The charging station or the operator thereof can also transmit updated price information, for example, to the server.

Accordingly, the provision of the database can mean that, through the server, the database is made available directly or indirectly to respective users via another data link or via a data or communication network, such as, for example, the Internet. An indirect provision of access can mean, for example, that data that has been retrieved from the database by the server at the request of a user or has been determined on the basis of the database can be transmitted to the respective user by the server. The server or the database can be, for example, part of a data processing center.

Depending on the inquiry, the selection of at least one charging opportunity from the database can be made, for example, by comparing, together with or as part of the inquiry, received data and/or criteria against the data stored in the database. It is then possible, for example, to select the charging opportunity that best meets the criterion or criteria or the requirements placed on the charging station, together with or as part of the inquiry, and/or to select the charging station whose data has the least deviation from the received data.

Thus, the inquiry can be more directed, for example, to a charging opportunity in a specific geographic and/or time range and/or with a specific minimum output of electrical power, and/or similar considerations. In this way, one charging opportunity per inquiry can be selected in each case. It is also possible, however, for a plurality of charging opportunities per inquiry to be selected—for example, in each case, all or a predetermined number of charging opportunities that have a predetermined degree of correspondence, such as, for example 80%, with the particular inquiry as described above. If a plurality of charging opportunities are selected, then they can be sorted according to their degree of correspondence, their geographic distance, the particular energy price, or the like, for example, and transmitted to the driver. The data that is stored in the database and correspond to the particular selected charging opportunity or to the particular selected charging opportunities can be transmitted to the driver, for example, via the Internet, preferably via a wireless connection. In this case, the transmission of the data to the driver can mean, in the sense of the present invention, that the data is transmitted to a corresponding receiving unit of the motor vehicle and/or to a terminal device and, in particular, to a mobile terminal device of the driver, such as, for example, a mobile phone or a computer. Said transmission can also mean that the data is made available or presented to the driver by way of, for example, a Web interface.

The reservation of the charging opportunity for the driver can be made, for example, by way of a corresponding entry in the database, which indicates that the reserved charging opportunity occupies a specific reservation period, that is, a time that is not available for other drivers or motor vehicles. The reservation period can be given, for example, directly through the inquiry or, for example, calculated individually by the server. For this purpose, it is possible, for example, to take into consideration the power of the charging station selected as part of the charging opportunity, an energy need of the motor vehicle, and/or additional data contained in the database and/or in the inquiry. The reservation can also mean or comprise a transmission of corresponding reservation information to the respective charging station. Accordingly, the reservation can be sent to the driver who sent the inquiry and/or it can be linked to a motor vehicle associated with said driver, so as to prevent any misuse. For this purpose, it is possible, for example, for the server to administer a database of profiles, in which corresponding registration data for the driver or for the user of the method are stored.

The database can be produced or expanded, for example, in that data corresponding to charging stations operated by operators or corresponding to charging opportunities are transmitted by the charging station operators and are received by the server and added to the database, that is, are stored in said database. Accordingly, it is possible for an operator of a charging station to provide said database to other drivers or users at times during which the operator does not himself utilize the database.

By way of the present invention, therefore, it is possible to create a system for organized collaborative utilization of charging stations, in which, advantageously, the numerous private charging stations already installed at the present time can be interconnected in an especially simple way. Thus, it is possible to improve the practical utility of electrically driven motor vehicles and, accordingly, the acceptance and spread thereof. Therefore, without the need to create a new extensive charging infrastructure, an increased flexibility in route planning of motor vehicles of this kind can be achieved, because, through utilization of the present invention by the particular driver, a larger number of charging opportunities than are available to said driver at present can be located and utilized in an especially simple manner. In this way, an average waiting time at charging stations can also be reduced advantageously.

Because the communication and reservation, that is, an allocation between the particular charging opportunity and the particular driver, can be realized centrally via the server, there also exists an especially simple option for the billing or invoicing for the energy procured by the particular driver or made available by the particular charging station operators. It is possible, for this purpose, to provide the personal data on file in the profile database, for example.

In one advantageous embodiment of the present invention, a confirmation signal sent by the driver is received by the server after the transmission of the data, and the charging opportunity is reserved only after the receipt of said confirmation signal. In other words, the inquiry can therefore be nonbinding, as a result of which the driver can advantageously initially be informed about the available charging opportunities. In accordance therewith, the driver can then make a new inquiry—for example, with modified criteria or specifications—to the charging opportunity, or make a binding confirmation of the charging opportunity transmitted by the server. Advantageously, a simplified handling is thus also made possible when, in response to the inquiry, the server selects a plurality of charging opportunities and transmits said charging opportunities or the corresponding data to the driver. In this case, the driver can then select one of said plurality of charging opportunities and confirm it in a binding manner, as a result of which, for the communication of the respectively optimal charging opportunity, less complicated or detailed inquiries are necessary. The sending of the confirmation signal can be triggered by the driver by way of, for example, the actuation of a corresponding control element at a device or instrument of the motor vehicle, at a terminal device, or in a Web interface.

In an advantageous embodiment of the present invention, as part of the inquiry, a navigation destination of the driver and a current state of charge of the traction battery of the motor vehicle are received. These specifications are then evaluated by the server for the selection of at least one suitable charging opportunity. For example, the navigation destination can be used for the purpose of selecting from the database one or a plurality of charging opportunities that are located within a predetermined distance range with respect to the navigation destination. The state of charge can be taken into consideration in order to determine, in combination with the electric charging capacity made available by the particular charging station, a charging time that is required for charging the traction battery, for example. It is possible in this way to schedule a full charging of the traction battery or a charging with a quantity of energy that is required to reach the navigation destination. The latter can be advantageous, in particular, in the case when the charging is necessary on the way to the navigation destination, but a further charging opportunity is provided at the destination. In order for a charging station to come into consideration as a charging opportunity and, accordingly, to be able to be selected, it must be free, that is, available, for example, for at least a span of time corresponding to the required charging time. The transmission and receipt of the navigation destination and of the current state of charge advantageously makes possible an improved selection of a suitable charging opportunity and, in particular, of the optimal charging opportunity. An optimal charging opportunity can be characterized, for example, by a minimum time required to reach the navigation destination and/or by the costs associated therewith.

In an advantageous embodiment of the present invention, as a part of the data, a list of charging opportunities in a geographic range described by a zip code or a plurality of zip codes is transmitted to the driver by the server. Said geographic range can, for example, be an area with a connected sequence of zip codes or a postal delivery area. In other words, charging opportunities in a predetermined geographic range are therefore selected and transmitted. The use of zip codes in this case makes possible an especially simple, rapid, and uncomplicated assignment or selection, because, for example, only the particular zip codes of charging opportunities on file in the database are retrieved and it is not necessary to carry out distance calculations. Preferably, the geographic range can be prespecified by a zip code of the navigation destination received with the inquiry or as a part of the inquiry. Accordingly, it is also possible, from the database, for the server to automatically determine charging opportunities that are located in a particular destination region of the driver.

In an advantageous embodiment of the present invention, a current location of the driver and/or of the motor vehicle is recorded by the server. Preferably, the corresponding specified location can be transmitted automatically, together with the inquiry or as a part of the inquiry, to the server by the driver. Alternatively, the current location can be requested or retrieved by the driver or by an instrument used by the driver for the inquiry or, for example, by another server device. The server then uses the current location as a starting point and the reserved charging opportunity as a waypoint to determine a navigation route. The navigation route is then transmitted to the driver. Therefore, in this case, the reserved charging opportunity can be a destination, that is, an end point of the navigation route or an intermediate destination. Because, in any case, the server has access to the address data of the charging opportunities on file in the database, it is thus advantageously possible to simplify and to accelerate the route guidance, since the driver need not himself be concerned with the procurement of the address data and, for example, the entry of said data in a navigation device. Preferably, therefore, the navigation route can be transmitted automatically by the server directly to a navigation device of the driver or of the motor vehicle. Preferably, the navigation route can be determined accordingly, taking into consideration a navigation destination of the driver that is received with the inquiry. Accordingly, is it advantageously possible to determine an optimal navigation route prior to or at the beginning of the drive. It is thereby possible to achieve a greater flexibility in the route guidance than would be possible when, for example, there is a drop below a specific state of charge only during the drive, so that charging opportunities located nearby would be sought.

Especially advantageously, it is possible in the determination of the navigation route by the server also to take into consideration the current state of charge of the traction battery. Thus, the server can determine, for example, whether the current state of charge is sufficient to reach the navigation destination or whether it would be necessary prior to reaching the navigation destination to schedule or drive toward a charging opportunity as an intermediate destination. It is thereby advantageously possible to ensure that a navigation route is transmitted to the driver and, in spite of the limited range of travel of the motor vehicle, guides the driver reliably to the driver's navigation destination.

In this case, the inquiry can include criteria, specifications, or conditions, such as, for example, a maximum length of stay at a charging station. Thus, a navigation route can also have, for example, a plurality of charging opportunities as waypoints. Advantageously, it is thus possible to provide a plurality of travel breaks for charging the traction battery on the way from the current starting point to the navigation destination, as a result of which stress on the driver is reduced and, accordingly, it is possible to improve the secure guiding of the motor vehicle.

In an advantageous embodiment of the present invention, as a part of the data, an authentication code is transmitted to the driver by the server. Said authentication code can then be used by the driver to authenticate the charging opportunity reserved for the driver. The authentication code can be generated, for example, by the server individually for each combination of driver or motor vehicle and reserved charging opportunity. As an authentication code, an alphanumeric string of characters can be used, for example. Especially advantageously, it can be provided that the procurement of electrical energy via the reserved charging station is only released, that is, made possible, when the authentication [code] or authentication of the driver or of the motor vehicle is made. Through a method of this kind, it is advantageously possible, for example, to prevent any unauthorized energy withdrawal at the charging station, so that there is no detrimental consequence to a respective operator even when said operator provides the charging station operated by it to other users without supervision.

In an advantageous embodiment of the present invention, a quantity of energy procured for charging the traction battery via the charging opportunity is recorded by the server. In other words, therefore, it is determined how much energy the driver has withdrawn at the charging opportunity or charging station. Said quantity of energy can be recorded or determined, for example, by a device of the motor vehicle or by a device of the charging opportunity or of the charging station and transmitted to the server or retrieved from the corresponding device by the server. The recording of the procured quantity of energy advantageously makes possible, for example, a precise billing.

In a preferred enhancement of the present invention, a consumption database is administered by the server, in which, for each user of the method, a respective energy procurement and a respective release of energy via the charging opportunities are stored. Users of the method are, in particular, the particular driver of the motor vehicle and the particular operator or vendor of the charging opportunity. For example, it is possible in each case to record or to book in a consumption database a negative balance for the user who is procuring energy and a positive balance for the user who makes available the charging opportunity and, accordingly, the energy. In other words, the consumption database administered by the server can therefore be designed as an account system in analogy to conventional bank accounts. Advantageously, it is thereby possible to exchange energy and charging opportunities among the users. In this way, it is advantageously possible to provide, for example, that a positive balance authorizes the procurement of a corresponding quantity of energy at one of the charging opportunities stored in the database.

The server can also serve as a commercial platform for the purchase and sale of energy and/or of usage authorizations for charging stations, that is, ultimately for charging opportunities. Especially advantageously, in the case of a user that operates a charging station and provides it to other users and also utilizes an electrically driven motor vehicle, the situation can ensue that said user is able to utilize the motor vehicle effectively without accruing costs for the operating energy thereof. For this purpose, for example, via the charging station that he operates, the user can make available energy from a solar energy installation or another renewable energy source, thereby building up a positive balance, and the user can use said positive balance to charge said user's motor vehicle, as needed, at other charging stations. Through a system and method of this kind, it is advantageously possible to improve the acceptance, utilization, and practicability of electric vehicles, in particular, and to create a motivation for making available charging opportunities. However, for example, it can also be provided that, for example, users who operate the charging station can acquire a positive balance via the server and, accordingly, in an especially simple and secure manner, as a result of which a simple and unified billing of procured energy is made possible, in particular at different charging stations.

Besides the method according to the invention, another aspect of the present invention is a storage medium with a program code, which, when it is executed by a processor device of a server, is established to implement at least one embodiment of the method according to the invention.

Another aspect of the present invention is a server device for operating a communication network, in particular on the Internet, wherein the server device comprises a storage medium according to the invention. The server device can have at least one microprocessor and/or at least one microcontroller, which is connected to the storage medium via a data link or via a memory unit interface.

The invention also includes a program code or an application, that is, a computer program that can be executed on a device, such as, for example, on a navigation device, of the motor vehicle and/or on a terminal device, in particular on a mobile terminal device (smartphone) and, when it is executed, makes possible the driver-end communication with the server in accordance with the method according to the invention. By means of said program code, for example, the driver is thus enabled to communicate the inquiry for a charging opportunity to the server and to receive data that corresponds to the selected charging opportunity and that is transmitted by the server.

The invention also includes enhancements of the program code according to the invention and of the server device according to the invention, which have features such as those described in connection with the embodiments and enhancements of the method according to the invention and vice versa. For this reason, not all embodiments and enhancements in accordance with the invention are explicitly described here for all aspects of the invention.

### BRIEF DESCRIPTION OF THE DRAWING

In the following, exemplary embodiments of the invention are described. Shown for this purpose is:

FIG. 1 a schematic illustration for explanation of a method for communicating a charging opportunity for a traction battery of a motor vehicle to a driver of the motor vehicle.

### DETAILED DESCRIPTION

In the exemplary embodiments explained in the following, what is involved are preferred embodiments of the invention. In the exemplary embodiments, the described components each represent respectively individual features of the invention that are independent of one another and each of which the invention further develops also independently of one another and, accordingly, are to regarded, also individually or in a combination different from that shown, as belonging to the invention. Furthermore, the described embodiments can also be supplemented by features of the invention further to those already described.

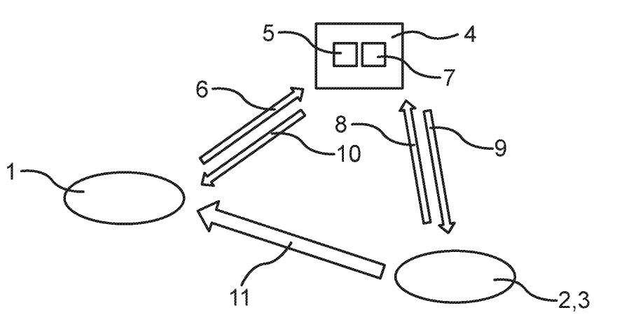

FIG. 1 shows a schematic illustration, on the basis of which, in the following, a method [is provided] for communicating a charging opportunity 1 for an electrically driven motor vehicle 2 to a user, in particular to a driver 3 of the motor vehicle 2. The charging opportunity 1 can be given, for example, by a charging station along with a period of time in which said charging station is available. In this case, the communication is made via a server 4, which communicates or can communicate via a respective data link, on the one hand, with the charging station or the operator thereof, and, on the other hand, with the driver 3 or the motor vehicle 2.

In vehicles with internal combustion engines widely used at the present time, the supplying of energy thereto, that is, the filling thereof with operating fuel, is made possible through a network of gas stations. In this case, the filling or tanking is possible very fast, for example within a few minutes. A correspondingly short charging time for charging a traction battery of the electrically driven motor vehicle 2 is not yet possible in accordance with the present-day prior art. Beyond this, at the present time, there are available markedly fewer charging stations for electric vehicles and hybrid vehicles than conventional filling stations. In particular, for the anticipated increasing widespread use of electrically operated motor vehicles 2, substantial waiting times, including a downright traffic jam, are to be expected at charging stations due to the required charging time as well as due to the small number of reasily available and public charging stations.

It is to be noted that drivers 3 of motor vehicles 2 with traction batteries typically have at their disposal a private charging station and often even their own possibility for energy production by means of, for example, a renewable energy source, such as, for instance, a photovoltaic unit. Therefore, in the private sector, the charging of the motor vehicle 2 takes place at private charging stations that can be utilized solely by individual drivers 3 of the motor vehicle 2. Excess energy produced by the renewable energy source is fed, for example, into a public power grid and payment for this is settled with an energy supplier. In spite of the relatively small number of public charging stations, therefore, there is indeed countrywide a markedly more extensive network of charging stations, of which, however, a large part have hitherto been used only privately or by single user.

An advantageous idea then consists in creating an option for making available the entirety of installed charging stations for a broader user base. An operator of a charging station can thus make available or offer said charging station to other drivers. If need be, accordingly, the energy produced by the renewable energy source can also be offered or made available via the charging station. This can advantageously be implemented in an especially cost-effective manner, because an involvement of a power grid operator or of an energy supplier can be dispensed with, provided that the respective legal regulations permit this.

For this purpose, it is provided in the present case that a data base 5, in which all available charging opportunities 1 or data corresponding to them—for instance, a respective address—are stored, is administered by the server 4. The charging opportunity 1 accordingly can be provided by a private or public charging station that is not being utilized at a specific period of time. A status, that is, for example, an availability, can be transmitted by the charging station in an automated manner, for example, in the form of supply offer data 6 to the server 4. The supply offer data 6 is received by the server 4 and stored in the database 5. The supply offer data 6 may comprise, for example, a period of time in which the charging station is free, that is, is available, an electrical power that can be called upon at the charging station, an energy price for the respective period of time, and/or more of the same.

In addition, the server 4 can administer a consumption database 7, in which, for each user, a provided and procured particular quantity of energy is stored. For example, the server 4 can administer a profile for each user, wherein, in this sense, users can be, for example, operators or vendors of charging stations and/or drivers 3 of electrically driven motor vehicles 2. The database 5 and the consumption database 7 can be integrated separately or in a comprehensive database.

At any desired point in time, the driver 3 can then send an inquiry 8 for a charging opportunity 1 to the server 4. Said inquiry 8 can comprise, for example, a navigation destination as well as a current location and a current state of charge of the motor vehicle 2. The inquiry 8 is received, evaluated, and compared by the server 4 against the charging opportunities 1 on file in the database 5.

A response to the inquiry 8 is transmitted to the driver 3 or to the motor vehicle 2 by the server 4, such as, for example, a suggestion or proposal 9 containing various charging opportunities 1 that are appropriate for the inquiry 8. The charging opportunities 1 that are appropriate for the inquiry 8 can be selected on the basis of a zip code of the navigation destination, for example, from the database 5. Thus, it is possible, for example, to suggest only those charging opportunities that lie in the same connected sequence of zip codes as the navigation destination. The proposal 9 can hereby preferably comprise a recommendation for a specific charging opportunity 1. The driver 3 can then transmit a specific charging opportunity 1 and a corresponding confirmation, that is, for example, a binding booking, to the server 4.

Through the server 4, the charging opportunity that has been confirmed by the driver 3 is then reserved. This can be carried out through a corresponding entry in the database 5. A corresponding reservation 10 can also be transmitted to the charging station associated with the charging opportunity 1 or to the operator thereof.

Because the server 4 has access to the location information, that is, to the addresses, of the charging opportunity 1, it is possible, for example, to transmit an appropriate navigation route 11 to the driver 3 or to the motor vehicle 2. Said suitable navigation route 11 can guide the driver 3 from the driver's current location or from the current location of the motor vehicle 2 to the charging opportunity 1. In this case, the navigation route 11 can be transmitted, for example, in an operation that is separate from the transmission of the proposal 9. The arrows that are illustrated here schematically and that represent a data exchange with the server 4 can therefore represent each of a plurality of separate data transmission operations.

An authentication code can also be transmitted to the driver 3 by the server 4, and with this code, the driver 3 can authenticate the charging opportunity 1. The corresponding authentication can be made at the charging opportunity 1, for example, through a corresponding data exchange with the server 4.

After the charging of the motor vehicle 2 at the charging opportunity 1 is concluded, the procured quantity of energy or the total price thereof can be entered in the consumption database 7. The quantity of energy or the total price thereof can be assigned to the driver 3 as a debit or consumption and credited to the operator or vendor of the charging opportunity 1 as a positive balance.

Through such an administration of supplied and procured energy, it is therefore possible to provide a direct and, if need be, also mutual exchange of charging opportunities or energy among users.

1. A method for communicating a charging opportunity for a traction battery of a motor vehicle to a driver of the motor vehicle, comprising the method steps:
provision of a database of charging opportunities by means of a server;
receipt of an inquiry for a charging opportunity from the driver by the server;
depending on the inquiry, selection of the charging opportunity from the database by the server;
transmission of data corresponding to the selected charging opportunity to the driver by the server;
reservation of the charging opportunity for the driver by the server.

2. The method according to claim 1, wherein charging opportunities offered by private persons are recorded in the database.

3. The method according to claim 1, wherein for each charging opportunity, a particular period of availability and/or a particular electrical power capacity is received by way of the server and is recorded in the database.

4. The method according to claim 1, wherein after the transmission of the data, a confirmation signal sent by the driver is received by way of the server, and the charging opportunity is reserved only after the receipt of the confirmation signal.

5. The method according to claim 1, wherein as part of the inquiry, a navigation destination of the driver and a current state of charge of the traction battery are received.

6. The method according to claim 1, wherein as part of the data, a list of charging opportunities in a geographic range described by a zip code or by a plurality of zip codes is transmitted by way of the server.

7. The method according to claim 1, wherein
a current location of the driver and/or of the motor vehicle is recorded by the server;
a navigation route with the current location as a starting point and the reserved charging opportunity as a waypoint is determined by the server; and
the navigation route is transmitted as part of the data.

8. The method according to claim 1, wherein as part of the data, an authentication code is transmitted to the driver by way of the server, and said driver can provide authentication with this code at the charging opportunity reserved for said driver.

9. The method according to claim 1, wherein a quantity of energy procured at the charging opportunity for charging the traction battery is recorded by way of the server.

10. The method according to claim 1, wherein a consumption database is administered by way of the server, and in database, for each user of the method, a particular energy procurement and a particular release of energy via the charging opportunities are stored.

11. A storage medium with a program code, which, when it is executed by way of a processor device of a server, is established for carrying out a method according to claim 1.

12. A server apparatus for operation in a communication network, having a storage medium according to claim 11.
